(19) United States
(12) Patent Application Publication
(10) Pub. No.: US 2024/0139562 A1
(43) Pub. Date: May 2, 2024

(54) ELECTRIC VEHICLE WITH FIRE SAFETY SYSTEM

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/385,242

(22) Filed: Oct. 30, 2023

Related U.S. Application Data
(60) Provisional application No. 63/420,489, filed on Oct. 28, 2022.

(51) Int. Cl. A62C 3/07

(52) U.S. Cl. CPC A62C 3/07

(57) ABSTRACT

One or more examples provide an electric vehicle or a device for use with an electric vehicle, including an electric vehicle charging system and method. In one example, the electric vehicle includes a fire safety system coupled to the battery pack.

### CROSS REFERENCE TO RELATED APPLICATION

This Non-Provisional Patent Application claims the benefit of the filing date of U.S. Provisional Patent Application Ser. No. 63/420,489, filed Oct. 28, 2022, which is herein incorporated by reference.

### TECHNICAL FIELD

The present disclosure relates generally to examples of electric vehicles and to devices for use with an electric vehicle, including electric vehicle power systems, electric vehicle batteries and electric vehicle charging systems and devices.

### BACKGROUND

Electric vehicles and electric vehicle devices provide quiet, clean, and efficient powertrains for moving from place to place or for getting work done.

Electric vehicles may start on fire due to overheating of the battery pack, a faulty battery, or exposure of a battery pack to outside chemicals. For example, saltwater leaking into a lithium-ion battery pack can result in a battery or electric vehicle fire or even an explosion. This has become even more apparent with the recent electric vehicles abandoned near the ocean due to hurricane flooding. It is also a concern for electric vehicles that operate in a saltwater environment. Once the saltwater recedes, salt bridges can be formed connecting and/or shorting battery electrodes. The shorted battery cell electrodes can result in electric vehicle fires or explosions. Once an electric vehicle fire has started, they can be difficult to extinguish.

For these and other reasons, there is a need for the present invention.

### SUMMARY

The present disclosure provides one or more examples of an electric vehicle and systems and/or devices for use with an electric vehicle. In one or more examples, the present design provides an electric vehicle with a fire safety system including an on-board fire suppression system. The on-board fire suppression system operates as a built-in fire suppression system for the electric vehicle.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle power systems, electric vehicle batteries or electric vehicle charging systems and devices.

FIG. 1 illustrates one example of an electric vehicle including a fire safety system.

FIG. 2 is a block diagram illustrating one example of an electric vehicle including a fire safety system.

FIG. 3 is a block diagram illustrating one example of an electric vehicle fire safety system.

FIG. 4 is a block diagram illustrating one example of an electric vehicle fire safety system detection system.

FIG. 5 is a diagram illustrating one example of an electric vehicle including a battery pack with a fire safety system delivery system.

FIG. 6 is a diagram illustrating one example of an electric vehicle fire safety system including a fire suppression system.

FIG. 7 is a diagram illustrating one example of an electric vehicle battery pack with a fire suppression system including a delivery system.

FIG. 8 is a diagram illustrating one example of an electric vehicle fire safety delivery system.

FIG. 9 is a diagram illustrating one example of an electric vehicle fire safety delivery system.

FIG. 10 is a diagram illustrating one example of an electric vehicle fire safety suppression system including a delivery system.

FIG. 11 is a diagram illustrating another example of an electric vehicle including a fire safety system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, snowmobiles, electric watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

One or more examples of the present application provide an electric vehicle. In one example, the electric vehicle includes an electric vehicle battery and other electric vehicle systems and devices, including an electric vehicle having a fire safety system. One or more features of electric vehicle systems and devices are described in further detail in the following paragraphs and illustrated in the Figures.

The present design provides an electric vehicle with a fire safety system including an on-board fire suppression system. The on-board fire suppression system can operate as a built-in fire suppression system for the electric vehicle.

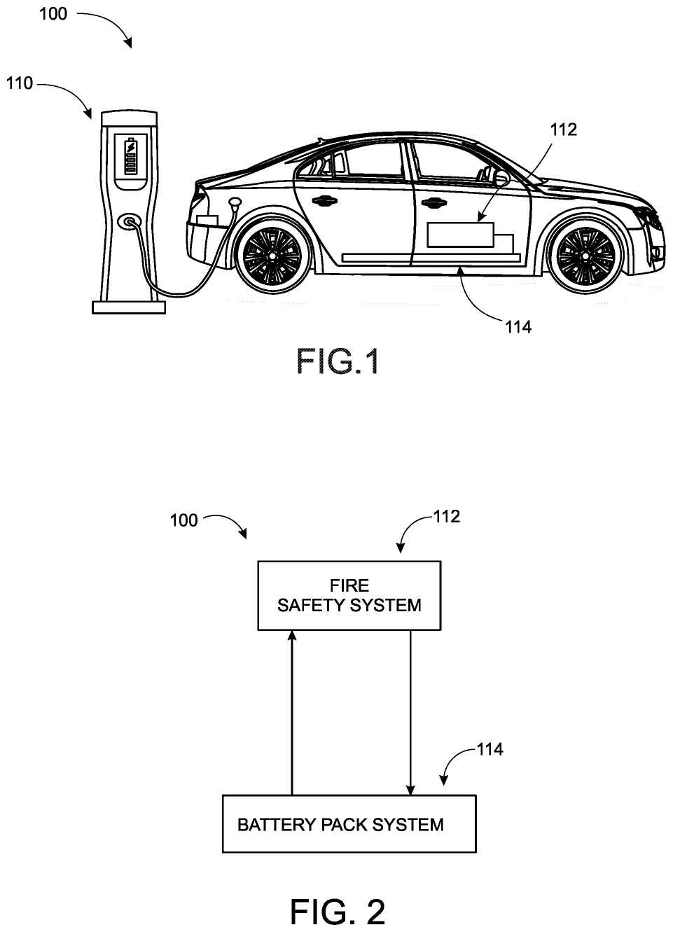

FIGS. 1 and 2 generally illustrate one example of an electric vehicle 100 including a fire safety system. The electric vehicle 100 is illustrated plugged into an electric vehicle charging station 110. The electric vehicle 100 includes a fire safety system 112 that operates to mitigate, stop and/or suppress electric vehicle fires including any damage to the electric vehicle due to the electric vehicle fire.

In one example, the fire safety system 112 is coupled to an electric vehicle battery pack 114. The fire safety system 112 operates to detect and suppress electrical vehicle fires due to battery failure, thereby mitigating damage to the electric vehicle 100 and objects near the electric vehicle.

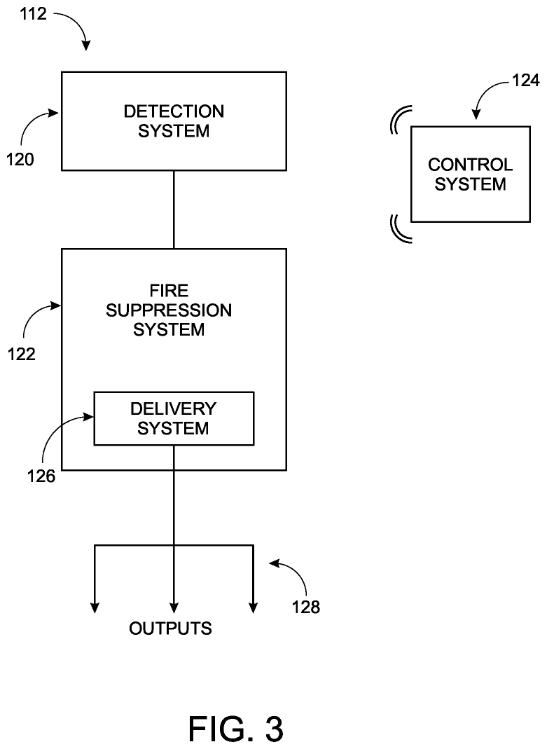

FIG. 3 is a block diagram illustrating fire safety system 112. Fire safety system 112 includes detection system 120, fire suppression system 122 and control system 124. The fire suppression system 122 includes a delivery system 126. In operation, the detection system includes one or more detectors for on-board detection (e.g., early or real time detection) of a possible alarm situation of a battery fault that may result in a fire. In response, the fire suppression system 122 activates delivery system 126 for delivery of a fire suppressant directly to the alarmed area (e.g., within the battery pack 114). In one or more examples, the delivery system 126 delivers fire suppression outputs 128 (e.g., a fluid in the form of a fire suppressant gas or liquid) to the battery pack. Control system 124 coordinates communication between the detection system 120 and fire suppression system 122. The detection system 120, fire suppression system 122, and control system 124 are described in detail in this specification.

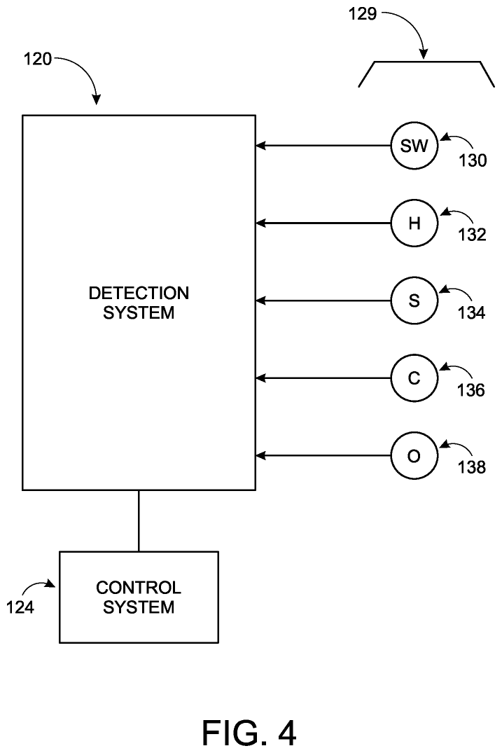

FIG. 4 is a block diagram illustrating one example of the detection system 120. The detection system 120 communicates with one or more sensors and/or fault detectors located in the electric vehicle. In one example, the sensors and detectors are located near or in the battery pack. Detectors 129 that are part of detection system 120 include one or more of the following detectors: saltwater detector 130; heat alarm detector 132; smoke detector 134; chemical detector 136 (e.g., indicative of a battery chemical leak); and/or other detectors 138. Control system 124 is in communication with detection system 120. The communication link between control system 124 and detection system 120 can be wired or wireless (e.g., bluetooth, BLE, RF, etc.). Upon detection of a possible alarm situation, detection system 120 communicates with control system 124. Control system 124 communicates with the fire suppression system 122, activating delivery system 122 to deliver a fire suppressant to the battery pack and/or alarmed area. In one example, a fire suppressant is selectively delivered only to the alarmed area, and not to the entire battery pack and/or every nozzle located at the battery pack.

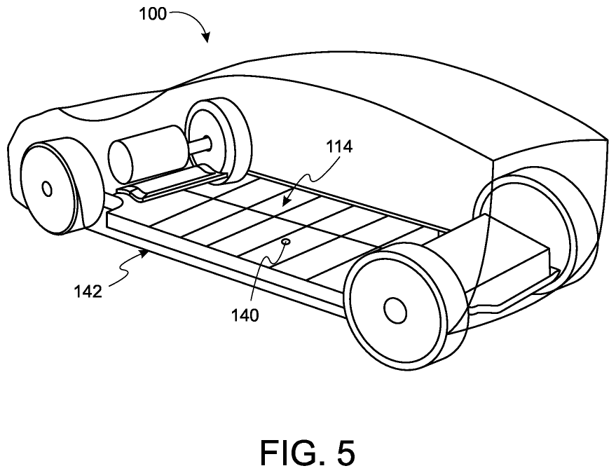

FIG. 5 illustrates one example of electric vehicle 100, including battery pack 114. The battery pack 114 is located in a hard to reach area within the electric vehicle. The battery pack 114 is located in an area between the wheel axles, and below the seats. The battery pack 114 includes one or more batteries 140 contained within battery housing 142. If a battery fault occurs within one of the batteries 140, the fire safety system 112 allows access to the battery 140 for minimizing or eliminating the risk of fire to the faulted battery.

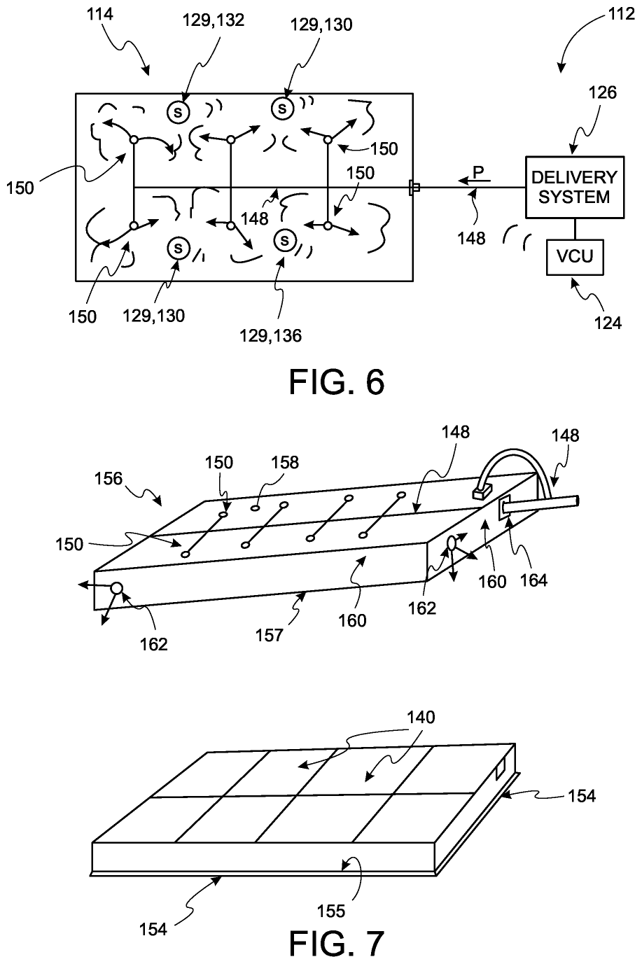

FIG. 6 is a diagram illustrating one example of fire safety system 112 including battery pack 114 and delivery system 126. Detectors 129 are located at battery pack 114. Detectors 129 are located both outside battery pack 114 and inside battery pack 114. In one example, a saltwater detector 130 is located outside of battery housing 142, and a saltwater detector 130 is located on the inside of battery housing 142. A heat detector 132 is located on the inside of battery housing 142 and a chemical detector 136 (e.g., a nickel sulfate or copper sulfate detector) is located on the inside of battery housing 142.

The delivery system 126 is in fluid communication with battery pack 114. Nozzles 150 are located at selected locations in battery pack 114. In one example, delivery system 126 includes delivery lines 148 routed to nozzles 150 at battery pack 114. In operation, a fire suppressant is routed to battery pack 114 under pressure via delivery lines 148. Nozzles 150 operate to release the fire suppressant at desired locations in battery pack 114. The fire suppressant is a pressurized fluid, and can be in liquid and/or gas form.

FIG. 7 illustrates one example of battery pack 114. The battery housing 142 includes a container 154 and a cover 156. A liquid tight seal 157 is located at an interface 155 between the cover 156 and container 154. Batteries 140 (e.g., one or more battery modules each having battery cells) are located within battery housing 142. The batteries can be any type of battery suitable for use with an electric vehicle. In one example, the batteries 140 are lithium ion batteries. In another example, the batteries 140 are solid state batteries. The batteries 140 fit within container 154. Housing cover 156 fits over batteries 140 and container 154.

Cover 156 includes a top 158 and sides 160. Valves 162 extend through cover 156. In one example, the one or more valves 162 extend through sides 160. The valves are one-way valves. In operation, when cover 156 is sealed to container 154 via seal 157, a one-way valve 162 provides a pressure release to the interior of housing 142. For example, if pressure builds up within housing 142 (e.g., due to a battery fault or outgassing of batteries), the one-way valves provide pressure relief. The valves 162 are designed to allow a certain or determined amount of positive pressure to be maintained and built up within the housing 412 before they release.

Delivery lines 148 extend through housing 142. In one example, deliver lines 148 extend through housing 142 at sides 160. A coupling device 164(e.g., a quick couple device) is located at side 160 allowing delivery lines 148 to extend through side 160. Alternatively, the coupling device can be located at top 158. Once delivery line 148 enters housing 142, the delivery line 148 can be in the form of separate individual tubes (e.g., plastic tubing), or can be channels molded into housing 142 such as cover 156. Alternatively, the delivery lines 148 can be routed on top of cover 156 and enter through the battery housing at nozzles 150 that extend on an interior side of the housing 150.

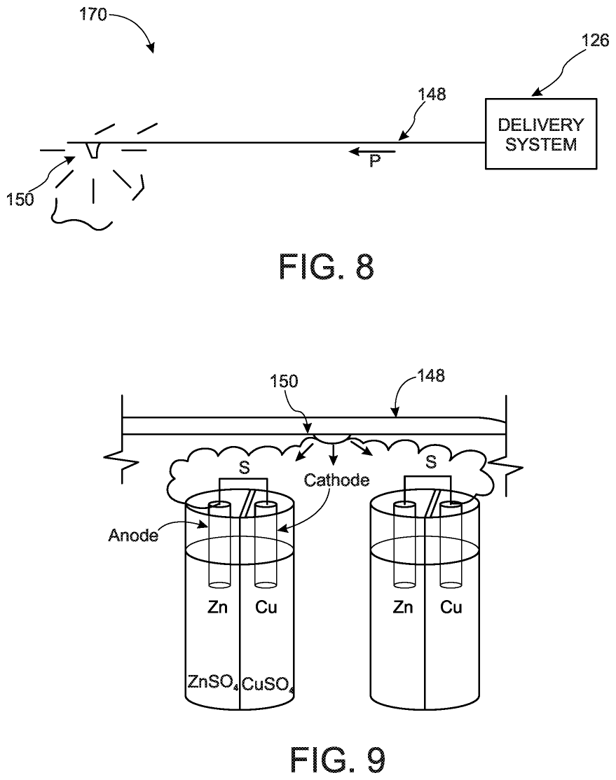

FIG. 8 is a diagram generally illustrating a portion of fluid delivery system 126 at 170. Fire suppression system 122 delivers fluid to be distributed (e.g., sprayed) at nozzle 150 via delivery system 126. Fluid is delivered under pressure P via delivery lines 148 to nozzle (s) 150. FIG. 9 is a diagram illustrating a battery cell 172 having a fault due to a salt bridge 174 between battery cell electrodes 176. Delivery system delivers a fire suppression fluid to the faulted area via delivery lines 148 and nozzle 150. In one example, nozzle 150 is a spray nozzle.

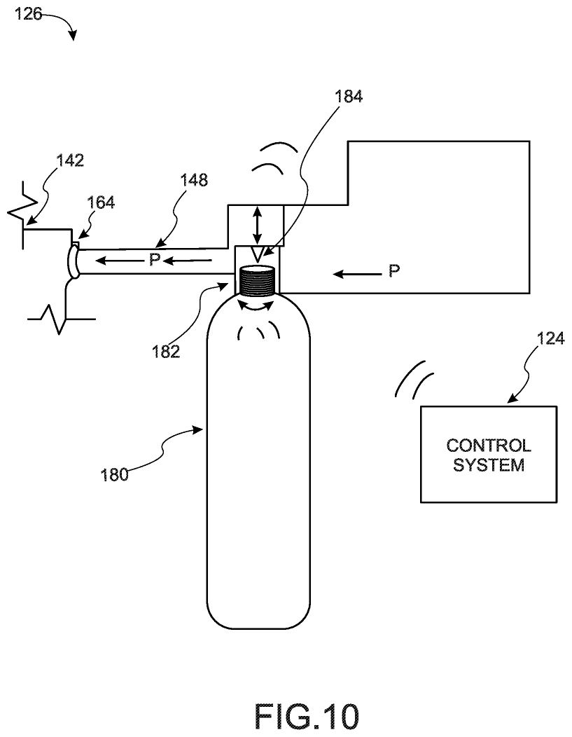

FIG. 10 is a diagram illustrating one example of a fire suppression delivery system 126. Container or canister 180 contains a fire suppression fluid. The fire suppression fluid is stored under pressure in the canister 180. Canister 180 is coupled to delivery system 126, inc fluid communication with delivery lines 148. In one example, the canister 180 is a replaceable, one time use or multi-time use canister. In one example, the canister 180 can be mounted in the delivery system 126 by simple coupling the bottle neck (e.g., by screwing it in) to the delivery system 126. In operation, delivery system 126 actuates device 184 thereby breaking the seal 182 of sealed canister 180. Once the seal 182 is broken, suppressant is delivered under pressure to an alarmed area via delivery system 126 delivery lines 148. In another example, the container or canister 180 is a refillable canister that is maintained under pressure. The fluid is released under pressure via actuation of a valve system.

In one example, the canister 180 contains a fire suppressant for a chemical fire similar to a chemical based fire extinguisher. In one example, the canister 180 contains a fire suppressant that eliminates the formation of salt bridges. In one example, the canister 180 includes halon. In one example, the canister includes one or more other chemicals suitable for eliminating a battery fire.

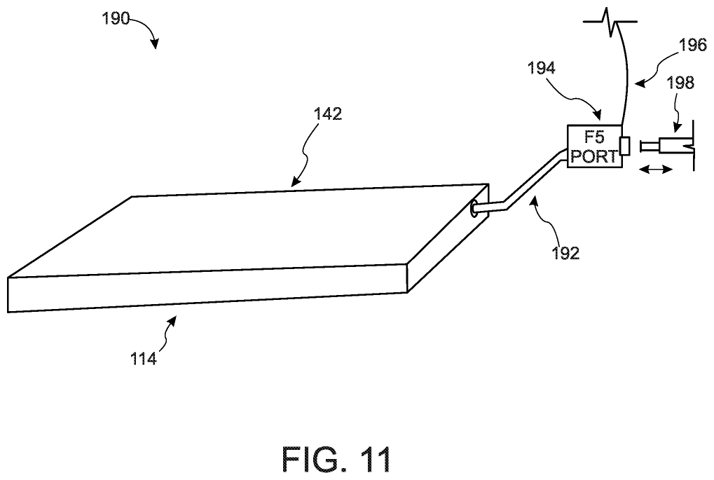

FIG. 11 is a diagram illustrating another example of an electric vehicle including a fire safety system, illustrated as fire safety system 190. The fire safety system 190 is similar to the fire safety systems previously described herein. Fire safety system 190 includes suppressant fluid delivery lines 192 coupled to a vehicle fire safety delivery port 194 (e.g., an external hook-up). The vehicle fire safety delivery port 194 provides a location for outside personnel to couple to the electric vehicle fire safety system and deliver fire suppressant fluid to an alarmed electric vehicle.

In one example, The electric vehicle delivery port 194 is an external hook-up connecting an external delivery system 198 to the on-board fire suppression system. The external hook-up can be located at the back, side, or front of the vehicle and may be suitable for allowing delivery to the vehicle of a fire suppression fluid, chemical or gas from a remote unit.

In one example, the external hook-up is located at the back of the vehicle, and comprises a delivery opening. The delivery opening may include a delivery cap. Additionally, a panel door may be provided for allowing access to the delivery cap/delivery opening. The panel door or delivery cap may or may not include a fire personnel lock. In operation, once an electric vehicle fire is detected fire personnel bring a tank of fire suppression material to the burning electric vehicle. The fire personnel connect the tank of fire suppression material (e.g., using a delivery hose) to the on- board fire suppression system using the external hook-up.

The panel door may be positioned at a predetermined location on the electric vehicle (such as in the front license plate area) or may be in a hidden location that is easily ascertainable and accessed by fire personnel.

The external hook-up may provide a quick-coupling system for coupling to an external delivery hose. Once the external delivery hose is connected to the external hook-up, fire suppression fluid (e.g., a liquid or gas) can be delivered under pressure to the battery pack, battery enclosure, or other desired locations about the electric vehicle.

### EXAMPLE 1

In one example, the electric vehicle 100 is configured as disclosed herein for mitigating damage due to exposure to saltwater. This design includes 1) a saltwater proof battery enclosure (hard or soft) and 2) a saltwater alarm system that includes a saltwater sensor within the battery enclosure. The design may also include a one-way valve for outgassing of the enclosure without allowing exposure to saltwater. Suitable for EVs that operate in saltwater environments such as locations near the ocean, or boats, PWCs or the EVs that operate on or near the ocean.

In one example, this design includes This design includes 1) a saltwater proof battery enclosure (hard or soft) and 2) a saltwater alarm system that includes a saltwater sensor within the battery enclosure that activates one or more of the following protocols:
provides a saltwater alarm;
activates the release of a solution to neutralize the saltwater;
disables the battery; and/or
releases a chemical compound for explosion containment or fire mitigation should the lithium-ion battery/saltwater combination cause the battery to catch fire or explode.

This design includes a battery shrinkwrap design or other outer layer design to provide an extra layer of protection/seal against saltwater penetration. The design may also include a one-way valve a detailed herein for outgassing of the enclosure without allowing exposure to saltwater.

EV with EV Battery having Saltwater Alarm. Saltwater leaking into a lithium-ion battery pack is an explosive combination. This has become even more apparent with the recent electric vehicles abandoned near the ocean due to hurricane flooding. These vehicles have experienced battery explosions or catching fire. It is also a concern for electric vehicles that operate in a saltwater environment. This design includes 1) a saltwater proof battery enclosure (hard or soft) and 2) a saltwater alarm system that includes a saltwater sensor within the battery enclosure. The design may also include a one-way valve for outgassing of the enclosure without allowing exposure to saltwater. Suitable for EVs that operate in saltwater environments such as locations near the ocean, or boats, watercraft or other electric vehicles that operate on or near saltwater (e.g., the ocean).

This design includes 1) a saltwater proof battery enclosure (hard or soft) and 2) a saltwater alarm system that includes a saltwater sensor within the battery enclosure that activates one or more of the following protocols:
provides a saltwater alarm;
activates the release of a solution to neutralize the saltwater;
disables the battery; and/or
releases a chemical compound for explosion containment or fire mitigation should the lithium-ion battery/saltwater combination cause the battery to catch fire or explode.

EV Battery Pack with Watertight Enclosure. Saltwater leaking into a lithium-ion battery is an explosive combination. This has become even more apparent with the recent electric vehicles abandoned near the ocean due to hurricane flooding. It is also a concern for electric vehicles that operate in a saltwater environment. Salt bridges can be formed connecting and/or shorting battery terminals.

This design includes a battery shrinkwrap design or other outer layer design to provide an extra layer of protection against saltwater penetration. The design may also include a one-way valve for outgassing of the enclosure without allowing exposure to saltwater.

### EXAMPLE 2

EV with EV Battery Early Fire Detection System. The electric vehicle includes an early fire detection sensor located at the battery pack. The sensor may be a heat, smoke, chemical or other type of early fire detection system. Once detected, the system can notify a user (e.g., via a cell phone app or the vehicle control unit) and provide an early warning audio and/or visual alarm.

The electric vehicle includes an on-board fire suppression system as detailed herein that includes one or more or the following features:
an on-board system that brings the fire suppressant directly to the battery pack via a delivery system;
the delivery system includes a system of watertight or gas-tight hoses suitable for delivering a chemical fluid or gas for suppression of the fire, directly to the source of the fire;
the fire suppression system is built directly into the battery enclosure and/or the battery pack enclosure;
the fire suppression system may include one or more gas or fluid spray nozzles at the battery pack or battery enclosure;
fire suppression material may be delivered to other parts of the electric vehicle, such as the electric motor or interior of the vehicle;
examples of fire suppression material may includes a chemical fluid or gas;
specific examples include a chemical fire retardant or halon;
the fire suppression material may inhibit or limit the ability of the forming of salt bridges at or within battery packs that lead to shorting and overheating of the battery;
one or more fire detection sensors and alarms may also be provided for early fire detection and indicating that a fire is present. The detection system may trigger a vehicle audible safety alarm, and also provide remote notification such as to a cell phone app or fire station.

### EXAMPLE 3

In one example, a battery failure (e.g., a battery short) is detected from the battery control system and one or more sensors/detectors are alarmed (e.g., battery over heating alarm, smoke alarm). The battery is disabled prior to a fire event.

Operation of the on-board fire suppression system operates to extinguish the electric vehicle fire. In other operations, the on-board electric vehicle system operates to aid in extinguishing the fire and mitigate damage to the electric vehicle due to the fire.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The following claims are part of the specification.

1. An electric vehicle comprising:
a battery pack; and
a fire safety system comprising:
an on-board fire suppression system including a fire suppressant delivery system;
a detection system associated with the battery pack including one or more detectors that provide early or real-time detection of a battery fire alarm situation, where upon detection of a battery fire alarm situation, the fire suppression system activates the delivery system to deliver a fire suppressant to an alarmed area; and
a control system that coordinates communication between the on-board fire suppression system and the detection system.

2. The electric vehicle of claim 1, comprising:
where the fire suppressant system delivers a fluid to the alarmed area.

3. The electric vehicle of claim 1, comprising:
where the detection system includes one or more detectors located near or in the battery pack.

4. The electric vehicle of claim 1, comprising a communication link between the detection system and the control system.

5. The electric vehicle of claim 1, comprising where the delivery system is routed into the battery pack for delivering a fire suppressant into the battery pack.

6. The electric vehicle of claim 1, comprising:
the battery pack includes an alarmed area and a non-alarmed area, where the delivery system selectively delivers a fire suppressant only to the alarmed area of the battery pack.

7. The electric vehicle of claim 1, comprising:
the fire suppressant delivery system is configured to deliver a fire suppressant both internal and external to the battery pack.

8. An electric vehicle comprising:
a battery pack; and
a fire safety system comprising:
an on-board fire suppression system including a fire suppressant delivery system;
a detection system associated with the battery pack including one or more detectors that provide early or real-time detection of a battery fire alarm situation, where upon detection of a battery fire alarm situation, the fire suppression system activates the delivery system to deliver a fire suppressant to an alarmed area; and
a control system that coordinates communication between the on-board fire suppression system and the detection system,
where the detection system includes a first detector located internal to the battery pack.

9. The electric vehicle of claim 8, the first detector comprising one of a heat detector, a saltwater detector, or a chemical detector.

10. The electric vehicle of claim 8, the detection system including a second detector located external to the battery pack, where the second detector is one of a heat detector, a saltwater detector, or a chemical detector.

11. The electric vehicle of claim 8, comprising:
the battery pack including a housing; and
the fire suppressant delivery system including a delivery line routed to an interior of the housing.

12. The electric vehicle of claim 11, comprising:
one or more nozzles located along the delivery line that aid in delivering a fire suppressant to an alarmed location.

13. The electric vehicle of claim 11, where the fire suppressant is delivered under pressure to the interior of the housing, where the fire suppressant is a pressurized fluid that is a liquid or gas.

14. The electric vehicle of claim 8, where the battery pack is located in a housing comprising a container and a cover, and a liquid tight seal at an interface between the container and the cover.

15. The electric vehicle of claim 14, comprising a pressure relief valve located in the housing.

16. The electric vehicle of claim 8, the fire suppression system including a canister coupled to the fire suppressant delivery system, where the canister contains a fire suppressant under pressure.

17. The electric vehicle of claim 16, where the canister is a replaceable canister.

18. The electric vehicle of claim 8, the fire suppression system including a fire safety delivery port coupled to the fire suppression system, the fire safety delivery port is in an exterior location suitable for external fire safety personnel to couple to the fire suppression system to deliver fire suppressant to an alarmed vehicle.

19. An electric vehicle comprising:
a battery pack including a saltwater proof battery enclosure; and
a fire safety system comprising:
an on-board fire suppression system including a fire suppressant delivery system;
a detection system including a saltwater alarm system associated with the battery pack including a saltwater sensor that provide early or real-time detection of a battery fire alarm situation, where upon detection of saltwater, the fire suppression system activates the delivery system to deliver a fire suppressant solution to an alarmed area to neutralize the saltwater; and
a control system that coordinates communication between the on-board fire suppression system and the detection system.

20. The electric vehicle of claim 19, comprising:
the detection system including a heat detector coupled to the control system, where upon detection of a heat alarm the control system disables the battery and activates the fire suppressant delivery system to release a chemical compound for explosion containment and fire mitigation.
